(19) United States
(12) Patent Application Publication
(10) Pub. No.: US 2008/0141813 A1
(43) Pub. Date: Jun. 19, 2008

(54) Device for Moving and Positioning an Object in Space

(76) Inventor: Matthias Ehrat, Lohn (CH)

Correspondence Address: SHOEMAKER AND MATTARE, LTD, 10 POST OFFICE ROAD - SUITE 110, SILVER SPRING, MD, 20910, US

(21) Appl. No.: 11/908,990

(22) PCT Filed: Mar. 15, 2006
(86) PCT No.: PCT/EP2006/060746

§ 371 Date: Sep. 18, 2007

(30) Foreign Application Priority Data
Mar. 18, 2005 (CH) 00466/05

(51) Int. Cl. B25J 17/02

(52) U.S. Cl. 74/490.01

(57) ABSTRACT

The invention relates to a device for displacing and positioning an object in space. Said device comprises a base element (1), three motor/transmission units (3) stationarily mounted on the base element (1), three arms (4, 5) which, at a first end, are firmly connected to the driving axle (2) of a motor/transmission unit (3) via a connecting flange (15) each with a single degree of freedom and which, at a second end, are articulated to a common support element (8) on which at least one gripper (8) for gripping the object is provided. A control and/or regulation unit (17) is provided on the base (1) and handles planning of movement of the support element (8) and regulation of the motor/transmission units (3).

### TECHNICAL FIELD

The invention relates to a device for moving and positioning an object in space according to the preamble of claim 1. Said device is referred to amongst experts as a robot with parallel kinematics or as a delta robot.

### PRIOR ART

A device of the generic type for moving and positioning an object in space is described in U.S. Pat. No. 4,976,582. This Delta robot has a base element with three actuators mounted to the base element. The three actuators are mounted in such a manner on the base element that one each of the actuator shafts typically runs along one side each of an equilateral triangle. To each actuator shaft the first ends of three arms are pivotably attached, such that each arm is individually driven by an actuator. The second ends of the three arms are hinge-connected individually by means of three gimbal mounted connecting elements or by means of three rod pairs with ball sockets to a common mounting plate. On this mounting plate there are arranged gripping means, for example a suction cup, for grabbing and holding the object to be moved. A telescopic fourth shaft, which is driven by a fourth motor, is hinge-connected to the fourth motor mounted on the base element and to the rotary feedthrough of the mounting plate.

These delta robots have proved themselves in automated plants, especially in the packaging and assembly industry. They have the advantage of being able to move at high speed, and yet precisely, between two positions and of being able to reach positions within a relatively large three dimensional space.

Typically, the motors of the actuators are coupled with the individual arms by means of a gear. These motor/gear units should require a reduced space for mounting and they should allow high, reproducible positioning accuracy of the gripping means without impact reactions related to a direction change, even in rapid start/stop operations. Further the gear units should be characterized by a low moment of inertia and they should be constraint-free, because otherwise the required dynamics would be limited and high dissipation loss would result, resulting in increased heat build-up. The gear units should thus be virtually free from backlash, allow rapid acceleration and have the smallest possible volume.

WO-A-03/106114 deals in detail with the problems of typical motor/gear units for fast-paced positioning applications with delta robots. In addition to the question of backlash limitation the same document in particular also addresses the objective of a calm operating attitude of the robot. WO-A-03/106114 proceeds from the conclusion that a gear exclusively free from backlash in the end positions is not sufficient for the required quiet running and positioning accuracy. WO-A-03/106114 suggests therefore measures, which affect the entire movement in the gear. The measures consist of applying tensioned gear transmission steps and to assemble these gear transmission steps favorably in material-conclusive manner by substance-tosubstance bonding. The tensioning of the gears however causes undesired squeezing and results in increased heat development.

The material-conclusive assembly permits a simplified production of the gears, excludes however their maintenance and leads, when using not sufficiently accurate components, to a bad vibration response due to unbalanced mass and due to uneven friction across the course of motion.

To achieve the desired reduced backlash, EP-A-1'129'829 suggests a rack and pinion transmission tensioned by means of a spring-loaded contact pressure roller, whereas the structural height, due to the rack and pinion mechanism, extends beyond the base element (1). This is disadvantageous, since the natural frequency behavior of the suspension device in which the robot is mounted deteriorates approximately in squared proportion to any increase in structural height.

WO-A-00/35640 uses a two-step spur gearing. The use of such a gearing is advantageous with regards to undesired heat buildup. However, comparable to EP-A-1'129'829, the use of a spur gearing results in increased structural height of the robot, resulting in an adversely affected natural frequency behavior and resulting in a requirement for increased headroom for the installation of a robot system. Further disadvantageous is the fact that the space required for mounting the motors and the spur gears does not leave installation space for further components such as a controller unit or servo amplifiers.

With serial robots, in particular with so-called SCARA robots, the controller unit can be integrated already today into the robot. The robot from U.S. Pat. No. 5,314,293 is known also in combination with an integrated robot controller and servo drive unit. For classical articulated robots a version with larger fitting space for a robot controller and a servo drive unit is shown in EP-A-1'437'162 likewise. In this fitting space a typical robot controller including controls and servo amplifiers, can be arranged. Such integration is simple to realize with serial robots, since more fitting space is available, and since the heat can the directly dissipated from the robot controller to the environment and finally since the vibration response of the robot is unproblematic due to the smaller cycle number.

With parallel robots, in particular with the delta robot in accordance with the principal claim of U.S. Pat. No. 4,976,582 the robot controller is however not yet directly integrated into the robot. U.S. Pat. No. 4,976,582 shows the fact that the main robot controller and the servo drive unit for the motors are connected with the robot by several cables and that they are not directly mounted to the base element. These cables prove to be unfavorable for the integration of delta robots into larger systems, since a high amount of work for passing the cables results. Further unfavorable are the resulting increased construction expenditures for the layout of cable troughings and control cabinets during the planning of such systems.

In different industrial applications a control cabinet was installed above the supporting frame of the robot, in order to work around this problem. Due to the arising oscillations and due to the bad accessibility in case of maintenance this solution is however not ideal.

U.S. Pat. No. 6,798,157 shows exemplarily a combined servo motor regulation and power amplification, which is based on semiconductor elements. Such semiconductor elements permit both a very compact design and thus the direct mounting of the regulation and amplification unit to the motor of a robot. The reduced heat build-up simplifies the design of the temperature heat sink.

### Representation of the Invention

The present invention aims to eliminate the constraint forces and the heat development in the gear/motor units of a delta robot by deploying untensioned gears and compact motors and to make possible thus a full integration of the drive units, the drive amplifiers and/or the control computer.

This task is preformed by a device with the characteristics of claim 1.

The delta robot according to the present invention features three actuators with in each case a gear, whose at least one reduction step, and/or their components, are gauged to each other during form-locking assembly by selective combination and fit of closely tolerated and accurate components, in order to adjust gear tolerances caused by production and to guarantee its play-poor run along the entire motion course.

The form-locking assembly, in combination with the adjustment and fit of the components in each of the at least one reduction steps of the gears, results in a very high rigidity of the actuators. The reduced play along the entire motion course improves the vibration behavior and the pick and place accuracy of the robot. Today no further disadvantages result from the use of untensioned gears regarding the size of the gears, but these gears are usually smaller and lighter.

Thereby the actuator can be designed very compact. Favorably the untensioned reduction steps of the gear are coaxially connected with the driving motor. In particular planetary gears are suitable. The driving motor can be very compact due to the small moment of inertia and due to the reduced constraint forces of the untensioned gears.

Finally the use of compact, oscillation-poor and thus high-dynamic actuators permits a partial or full integration of the drive electronics and of the robot controller. A further aspect of the invention concerns therefore a device with at least one control and/or drive unit arranged on the base element. In completely integrated robots, which encompass the entire control and/or drive unit, the required temperature heat sink can be realized and additionally due to the small vibrations the demanded longevity of the control and/or drive unit is guaranteed by the preferential use of untensioned gear units and given their small friction losses.

A completely integrated robot, encompassing the required functions of the control and/or drive unit, proves as substantially simpler to integrate into a complete robot line. Today the control and/or drive unit are mounted mostly separately in a control cabinet. Between the control cabinet and the robot several cables are then laid. This frequent source of error and the work connected with the wiring can be strongly reduced or avoided completely by the integration of the control and/or drive unit into the robot.

A further advantage consists of the fact that the product feeding and product eduction, like conveyors or container chains, and appropriate sensors or cameras, can be steered directly by the control unit of the integrated robot. Thus product infeed and outfeed conveyors or container chains can be integrated substantially more simply into a total conception of a system. So for instance the sensors and cameras mounted usually in direct proximity of the robot can be connected with the control unit of the robot by means of a short signal cable, while with a separately arranged control cabinet additional complex wirings are necessary.

Further advantageous embodiments derive from the dependent claims.

### DRAWINGS

The subject of the invention is explained below with reference to a preferred illustrative embodiment represented in the appended drawings, in which:

FIG. 1: shows a perspective representation of a delta robot

FIG. 2: shows a schematic representation of a motor (3b) and gear (3a) configuration in a motor/gear unit (3) in a delta robot according to FIG. 1

FIG. 3: shows a detailed representation of an integrated control and/or drive unit (17) in a delta robot according to FIG. 1

FIG. 4: shows a detailed representation of a configuration according to FIG. 3 with control and/or drive components (3c) directly affixed to the motor (3b) in a delta robot according to FIG. 1

### WAYS OF REALIZING THE INVENTION

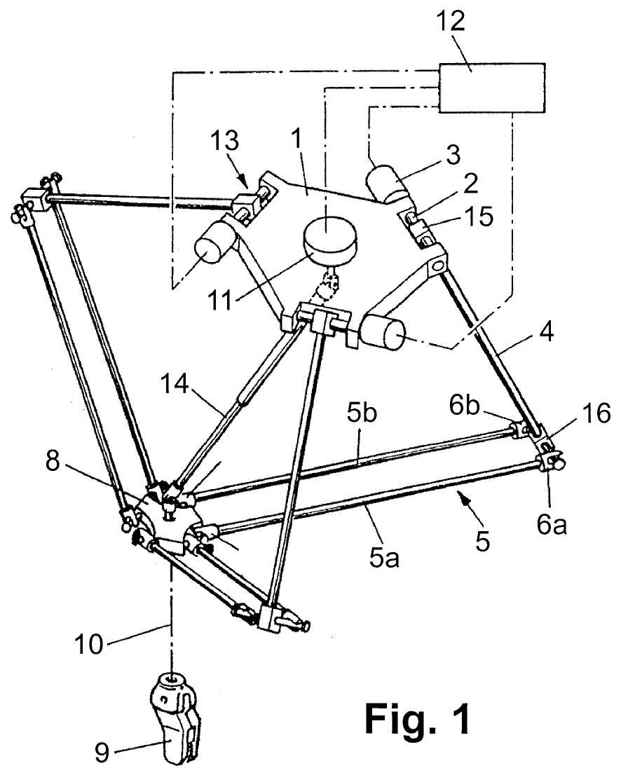

In accordance with FIG. 1 a delta robot incorporates a base element (1), three upper arms (4) which at one end are rigidly connected by means of a connecting flange (15) with the drive axle (2) of a motor/gear unit (3) and which at a second end (16) are pivotably connected with ball cups (6a, 6b) each with a pair of lower arm rods (5). The delta robot further incorporates a common carrying element (8), which is likewise pivotably connected with ball cups (7a, 7b) to the lower end of the three pairs of lower arm rods (5a, 5b). At the carrying element (8) at least one grab means or tool (9) is arranged for gripping or processing an object. Preferably there is furthermore arranged centrically relative to the upper linkage of the three upper arms (13) a telescope axle (14), which at the upper end is cardanically connected with an actuator (11) and which is cardanically connected at the lower end with the rotating shaft (10) of the tool-holding fixture of the carrying element (8). The axes (2) of the three motor/gear units (3) firmly fastened to the base element (1) form usually an equilateral triangle. Here each motor/gear unit (3) is connected with the control (12) represented outside of the robot.

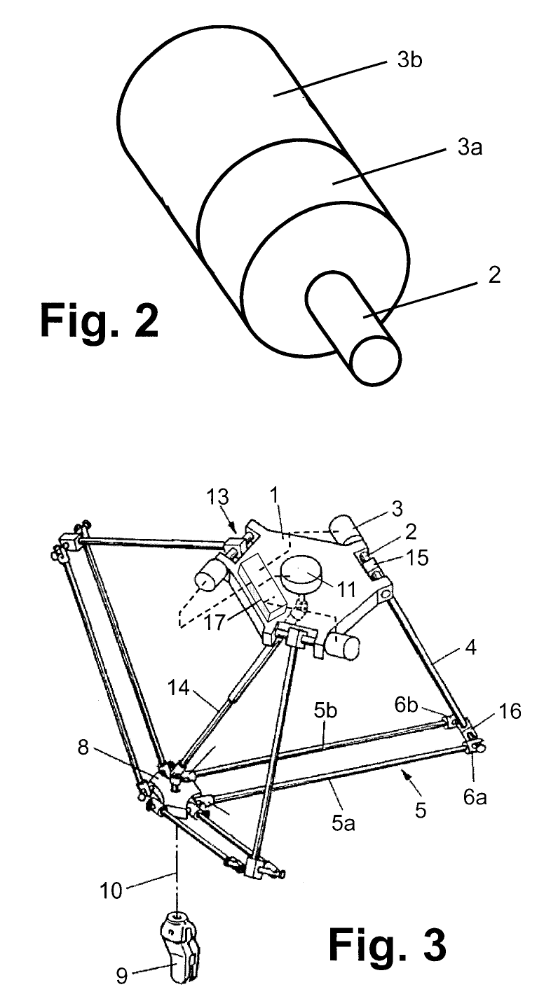

FIG. 2 shows a schematic representation of the motor/gear unit. Each unit comprises a motor (3b) and a gear (3a), connected coaxially with the motor (3b), with a driving axle (2). Due to the high number of revolutions to be achieved in the reversing operation mode of up to 250 revolutions per minute at the driving axle with 180 cycles per minute, only gears which are appropriate for a high-dynamic operation mode are suitable for the practical execution of the invention.

Few suitably are so-called Harmonic-drive. Likewise ill-suited are pin-welded planetary gears as described in DE-A-100'58'192 or tensioned planetary gears. Also not suitable are planetary gears with rollers for power transmission usually applied in robotics. These gears reach an output speed of at the most 100 revolutions per minute. At higher revolutions these are self-blocking, in order to avoid overheating. Likewise with these planetary gears the maximally permissible noise level of 70 d3 is reached already at 100 revolutions per minute.

Recommended are untensioned planetary gears, which are mounted in form locking manner and which are assembled symmetrically. It is to be noted that the demanded output speed of up 250 revolutions per minute in reversing operation mode at 180 cycles per minute has to be reached quickly. That is accomplished by a gear ratio of at least 1:30 and at the same time a high permissible number of revolutions at the gear input. In order to achieve the required positioning accuracy, the play ideally is in the range of between 1′ and 5′. Applied are therefore narrowly tolerated and untensioned, eventually multi-stage, precision planetary gears. The material choice and the closely tolerated fit of the coaxially assembled transmission components of these gears ensure that the shifting of the planetary wheels in the sun wheel successfully functions during high-dynamic cyclic operation in the demanded accuracy without shocks and without self blocking. Additionally the rotating rigidity and thus the positioning accuracy can be increased by a cage execution of the planet pinion cage.

As far as possible the bearings of the planetary gears, the planet pinion cage and the sun wheel are to be assembled with press fit in order to durably reduce or ideally to prevent shifting or play between the bearings, the planetary gears, the planet pinion cage, and as well the sun wheel. For applications in the highest performance range, noise can be kept durably under 70 dB by using a more elaborate helical gearing. These gears can be combined very simply with a servo motor, whereby individual manufacturers already offer integrated solutions.

As a consequence of the installation of such compact actuators and provided an appropriate constructive design of the base element (1), sufficient space is available for the receptacle of the control and/or drive unit. Their life expectancy is likewise barely affected given the low tendency to vibrate and given the limited heat build-up. An execution according to the invention is represented in FIG. 3. The motor/gear units (3) are arranged in conformity with FIG. 1. In addition a control and/or drive unit (17) is arranged on the base element (1), which is connected with the motor/gear units (3) and with the motor (11) of the fourth, telescopic axis (14). A control and/or drive unit can encompass the following components:
A control computer for the path planning of the robot, for the control of external periphery and for the evaluation of sensors such as cameras, rotary encoders or optical sensors
A drive unit for the three motors (3b) and if applicable the motor (11) of the telescopic axis (14)

In practice the control computer is frequently called robot controller. By the use of compact industrial computers the controller can be arranged on a small area.

The drive unit in practice is composed typically of three motor drives—for example servo amplifiers—for the motors (3b) and if required a fourth motor drive—i.e servo drive—for the motor (11). Beside the typical integrated servo amplifiers for control cabinet installation, which predominantly consist of regulation electronics, an electric rectifier, power sections for mostly three motor phases and a brake resistor with accordingly laid out cooling sections, compact automatic drive controllers which are based on semiconductor elements and which are supplied by only one separate electric rectifier are likewise applied. Most suitable for it are for example so-called ,insulated gate bipolar transistors” or abbreviated IGBT elements. For lower direct current link voltage the comparably built ,metal-oxide semiconductor field-effect transistor”, or briefly MOSFET elements, are also suitable. Well-known examples are TrenchStop IGBT Duo Pack manufactured by Infineon or iMotion from International Rectifier. By applying such power modules the drive unit (17) can be built very compact. The likewise necessary electrical brake resistor ideally is connected to the shared intermediate direct current link of all three or four actuators and directly attached in heat conducting manner to the base element (1), so that the power dissipation does not have to be exhausted over separate cooling elements. The short cabling between the drive unit and the actuators further simplifies control over electrical noise effects.

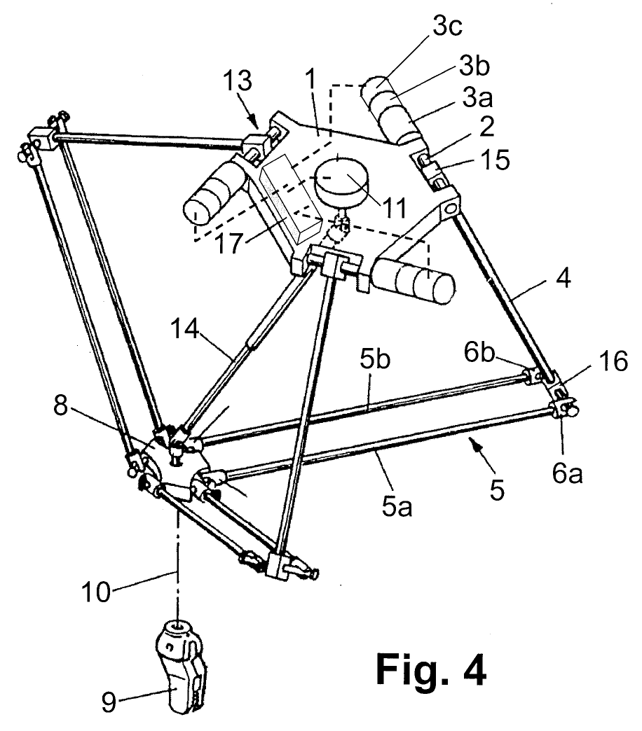

Instead of the combination of the automatic drive controllers for the motors (3b, 11) in a drive unit (11), FIG. 4 shows a further execution according to the present invention. In conformity with FIG. 3 a control and/or drive unit (17) is arranged on the base element (1) too. This unit incorporates primarily the control unit. Additionally further control and/or drive components (3c) are arranged on the motors (3b) oppositely to the gears (3a) These control and/or drive components (3c) can process signals of the motor/gear units and/or can feed the motor/gear units with power. By employing such a compact automatic drive unit, for example built from IGBT elements, in each control and/or drive unit (3c) the entire motor/gear unit can be implemented as one sub-assembly consisting of gear, motor and servo drive. Accordingly the assembly of the robot and the exchange of sub-assemblies during maintenance are simplified.

Devices according to the present invention and in compliance with FIG. 2, 3 or 4 make an extended deployment of the delta robot possible. By the use of untensioned transmissions and by the integration of control and/or drive components, the robot becomes easier to integrate, needs less space and features nevertheless a high positioning accuracy and optimal vibration characteristics.

1-14. (canceled)

15. A device for moving and positioning an object in space, the device comprising
a base element,
three motor/gear units arranged on the base element, and
three arms, each of which is attached at its first end to a motor/gear unit and is hinge-connected at its second end each to a common carrying element, at which at least one gripping element for gripping articles or parts is arranged, the motor/gear units being arranged in a plane defined by the base element or in a plane parallel thereto so that they form the outer edges of a triangle, and further comprising
a control and/or drive unit arranged on the base element

16. A device as claimed in claim 15 wherein the control and/or drive unit are formed by the drive controls and/or servo amplifiers of the motor/gear units.

17. A device as claimed in claim 16 wherein the control and/or drive unit comprises control and/or drive components mounted directly to the motor/gear units and the control and/or drive components are the drive controls and/or servo amplifiers of the motor/gear units.

18. A device as claimed in claim 16 wherein the power amplification of the motors is generated with semiconductor elements, preferably power transistors.

19. A device as claimed in claim 15 wherein the control and/or drive unit comprises a computer unit for the trajectory generation of the movements of the carrying element.

20. A device as claimed in claim 19 wherein the computer unit of the control and/or drive unit also computes and controls the motions of product infeeds and product outfeeds.

21. A device as claimed in claim 15 wherein the control and/or drive unit are connected in heat-conducting manner to the base element.

22. A device as claimed in claim 15, wherein each motor/gear unit is equipped with a non-tensioned gearbox, whose drive end of at least one reduction stage, preferably all reduction stages, runs coaxially to its output end.

23. A device as claimed in claim 22 wherein the at least one transmission step of the gearbox is a planetary gear, and the gearbox by positive locking assembly of closely tolerated gear components operates with reduced play all along its motion.

24. A device as claimed in claim 23 wherein the planet pinion cage of the gearbox is executed as a cage with recesses for the planet wheels, whereby the cage is pivoted circularly in the annulus of the gearbox.

25. A device as claimed in claim 15 further comprising a rotatable and length-adjustable fourth axle, which is connected by gimbal-mounting both with the actuator for the fourth axle and with the carrying element.

26. A device as claimed in claim 15 wherein each motor/gear unit has a gearbox, at least one gear step of which is tensioned, and wherein the gearbox, by virtue of material-locking and/or positive locking connection of gearing components, is free or virtually free from backlash over the whole of the motional range of the gearing.

27. A device as claimed in claim 15 wherein each motor/gear unit is implemented without transmissions, and that the motor shaft is the drive shaft and is directly connected to the connecting flange of the upper arms.
